(19) United States
(12) Patent Application Publication
(10) Pub. No.: US 2009/0030896 A1
(43) Pub. Date: Jan. 29, 2009

(54) INFERENCE SEARCH ENGINE

(75) Inventors: Robert JENSEN, Fredericia (DK); Anders LEHMANN, Holstebro (DK)

Correspondence Address: PILLSBURY WINTHROP SHAW PITTMAN, LLP, P.O. BOX 10500, MCLEAN, VA, 22102, US

(73) Assignee: AutIQ AS, Fredericia (DK)

(21) Appl. No.: 12/177,473

(22) Filed: Jul. 22, 2008

Related U.S. Application Data
(60) Provisional application No. 60/951,322, filed on Jul. 23, 2007.

(51) Int. Cl. G06F 7/06; G06F 17/30

(52) U.S. Cl. 707/5; 707/E17.014

(57) ABSTRACT

A system and method for processing an electronic query that includes defining a set of rules accessible to an inference engine and wherein the set of rules are configured for (a) parsing the query into one or more subsequent-queries; and (b) determining whether additional information is necessary to answer each subsequent-query and, if so, (i) accessing a registry containing descriptions of one or more data resources, (ii) analyzing the descriptions of the one or more data resources to locate information responsive to the subsequent-query; and then the system and method could apply the set of rules to the information, aggregate all of the information responsive to the query, and supply an answer to the query that is compliant with the set of rules.

### CROSS-REFERENCE TO RELATED APPLICATIONS

The present application claims the benefit of priority to U.S. provisional application Ser. No. 60/951,322, filed Jul. 23, 2007. The entire contents of the '322 application is incorporated herein by reference.

### BACKGROUND OF THE INVENTION

1. Technical Field

The present invention relates to the use of an inference engine to provide a response to electronic queries.

2. Description of Related Art

Conventional database systems can include an inference engine that processes instructions within the limitation of a provided set of rules. Conventional database systems can also utilize a plurality of tables to store information such as users, relationship of users, and access privileges of users. Tables can also store information related to other databases within or outside of a collection of databases. A Federation is one example of such a database system.

In the context of a search engine, this tabled information is typically referred to as a pointer, as it points to a specific database location. In non-relational “hierarchical” and “network” databases, records in one file contain embedded pointers to the locations of records in another, such as customers to orders and vendors to purchases. These are fixed links set up ahead of time to speed up daily processing. Another type of non-relational database is the object database, which stores data consistent with their object model.

For example, in a traditional approach to implementing a Federated Configuration Database (FCMDB), the federation of data sources is established by fixed pointers to the additional data sources. This enables a single point of access to a repository consisting of multiple data sources. Conventional systems and methods for electronic searching of information typically rely on the structure of such database systems.

Search engines have been employed to assist a user to locate information on, for example, their hard drive, a local area network, wide area network, or even the internet as a whole.

Routine queries to a relational database often require data from more than one file. For example, to obtain the names of customers who purchased a particular product, data must be extracted from both the customer and order files. A relational DBMS has the flexibility to join two or more files by comparing key fields such as account number and name and generating a new file from the records that meet the matching criteria. In practice, such a pure relational query can be very slow. In order to speed up the process, indexes are built and maintained on the key fields used for matching.

While much progress has been made in this field, improvements to search engines are being realized all the time.

### BRIEF SUMMARY OF THE INVENTION

It is an aspect of the present invention to provide a system and method for processing and responding to electronic queries. In one or more such systems and/or methods is an inference engine. In addition, the system can automatically and dynamically connect to internal and external data sources to gather the information needed to answer queries from a user, wherein a user can be a human being or another computer. When queries are made to the primary data source, the system investigates if the relations and contents of the primary data source are sufficient to answer the query. The system can then answer the query or, if the information in the primary data source is not sufficient to answer the query, the system can determine and access another available database, and so forth, until the query is answered in a more complete manner.

In one or more aspects, is provided a registry that can be queried to find the needed data sources, possibly establishing a federation, and queries to these data sources are created. The queries to the data sources are preferably related to a set of rules that relate to such things as interconnections and query language of the data source. The queries are then performed to gather the needed information. The gathered information can then be aggregated and/or merged with information from other queries, such as that from a primary data source, and used to supply an answer to the query.

Provided herein is a method for processing an electronic query that can include providing the query to an inference engine and using the inference engine for (a) accessing at least one first data source for information responsive to the query and (b) determining whether additional information is necessary to answer the query. If additional information is deemed necessary, then the inference engine can be used for (i) accessing a registry containing descriptions of one or more additional data sources, (ii) analyzing the descriptions of the one or more additional data resources to identify at least one additional data source relevant to the query, and (iii) accessing the at least one additional data source for information responsive to the query. The inference engine can then be used for aggregating all of the information responsive to the query and then supplying an answer to the query.

In one or more aspects the descriptions are amenable to analysis by the inference engine.

In one or more aspects the inference engine is configured to automatically update the registry. The registry can also be configured to be manually updated by an authorized user.

In one or more aspects the query is filtered into one or more subsequent queries. The scope of the answer is preferably commensurate with the scope of the query.

Also provided herein is a method for processing an initial electronic query that can include defining a set of rules accessible to an inference engine and wherein the set of rules are configured for parsing the initial electronic query into one or more subsequent queries; accessing a registry containing descriptions of one or more data resources; analyzing the descriptions of the one or more data resources to locate information responsive to the subsequent-query; applying the set of rules to the information; aggregating all of the information responsive to the query; and then supplying an answer to the query that is compliant with the set of rules.

In one or more aspects the initial electronic query is supplied by a user. The user can be human; the user can also be a computer.

In one or more aspects the scope of the answer is commensurate with the scope of the initial electronic query. In addition, the set of rules are configured to further parse at least one of the one or more subsequent queries into one or more extended queries. It should also be understood that the one or more extended queries can be as broad or broader than the subsequent query or initial electronic query from which it is derived. Likewise, the one or more subsequent queries can be as broad or broader than the initial electronic query from which it is derived.

In one or more aspects the descriptions are amenable to analysis by the inference engine. The descriptions can include the type of information stored in the at least one additional data source. The descriptions can also include instructions for accessing or querying the at least one additional data source.

In one or more aspects the inference engine is configured to automatically update the registry. By way of non-limiting example, the inference engine can automatically update the registry by scanning for changes to the at least one or more additional data sources. Again, by way of non-limiting example, the inference engine can specifically scan for changes to the existence of, location of, and/or contents of the at least one or more additional data sources. In addition, the registry can also be configured to be manually updated by an authorized user.

In one or more aspects the inference engine includes hardware-encoded instructions, software-encoded instructions, or both.

Finally, the method can include a set of rules that are further configured for determining what information is necessary to answer each subsequent query.

Also provided herein is a system that can include a first data source; a registry that further comprises a set of descriptions of at least one additional data source; an inference engine configured to (a) receive a query, (b) access the first data source in order to obtain information responsive to the query and, if necessary, (c) consult the registry in order to locate and access an additional data source in order to obtain information responsive to the query; as well as an aggregation module configured to collect the information and respond to the query.

In one or more aspects of the system, the descriptions are amenable to analysis by the inference engine. The inference engine can be configured to automatically update the registry, or the registry can be configured to be manually updated by an authorized user.

In one or more aspects of the system, the inference engine can include hardware-encoded instructions, software-encoded instructions, or both.

In one or more aspects, the system can include descriptions that further include the type of information stored in the at least one additional data source. The descriptions can also include instructions for accessing or querying the at least one additional data source.

In one or more aspects of the system, the inference engine automatically updates the registry by scanning for changes to the at least one or more additional data sources. By way of non-limiting example, the inference engine can scan for changes to the existence of, location of, and/or contents of the at least one or more additional data sources.

In one or more aspects, the system can include a linguistic filter configured to parse the query into one or more subsequent-queries.

In one or more aspects of the system, the information responsive to the query or subsequent-queries is commensurate in scope with the query or subsequent queries, respectively.

Put another way, on one or more aspects is provided of a system that comprises a first data source; a registry that further comprises a set of descriptions of at least one additional data source; an inference engine configured to: (a) receive a query, (b) access the first data source in order to obtain information responsive to the query and, if necessary, (c) consult the registry in order to locate and access an additional data source in order to obtain information responsive to the query; and an aggregation module configured to collect the information and respond to the query.

Other objects, aspects, and advantages of the present invention will become apparent from the following description, the accompanying drawings, and the appended claims.

### BRIEF DESCRIPTION OF THE DRAWINGS

FIG. 1 is a block diagram of a system in accordance with an aspect of the present invention.

FIG. 2 is a flow chart illustrating a process fulfilling a user query using the system of FIG. 1 in accordance with an aspect of the present invention.

FIG. 3, a continuation of FIG. 2, is a flow chart illustrating a process fulfilling a user query using the system of FIG. 1 in accordance with an aspect of the present invention.

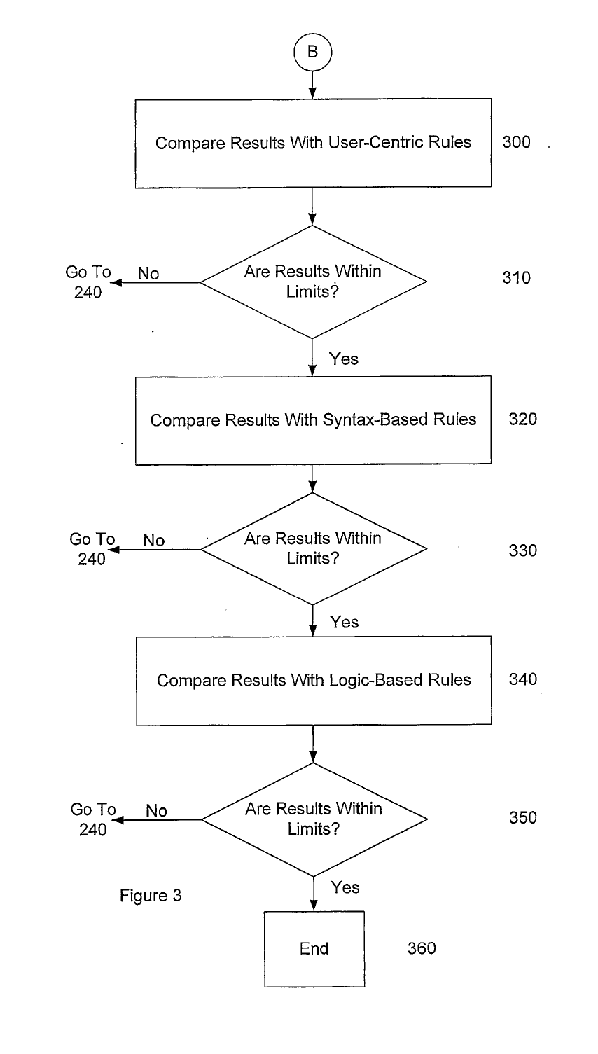

### DETAILED DESCRIPTION OF THE INVENTION

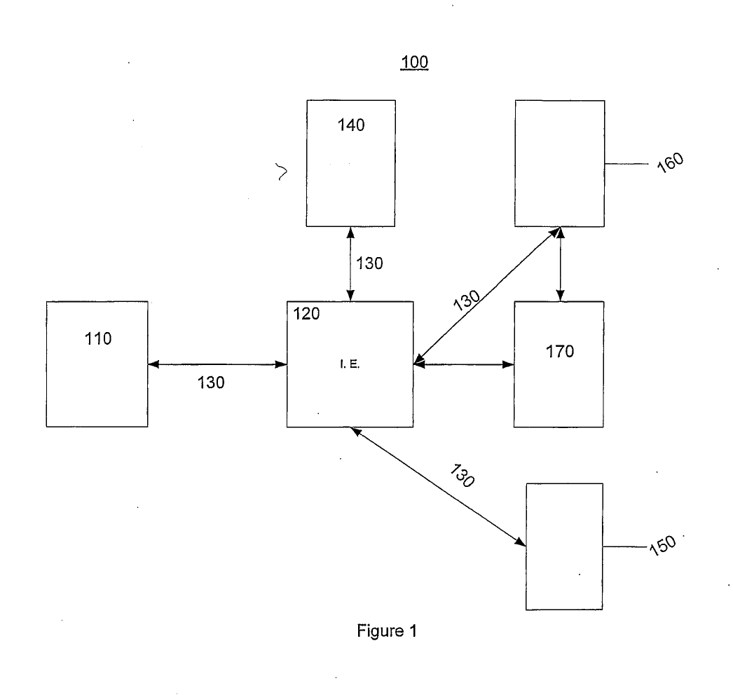

FIG. 1 illustrates a block diagram in accordance with an aspect of the present invention indicated generally by 100. An input 110 is transmitted to an inference engine 120. In some aspects of the invention, the input 110 may be a query manually entered in a computer or an interface device, which is transmitted to the inference engine 120 through a network 130. In other aspects of the invention, the input 110 may be a query from another computer.

The inference engine 120 is in communication with at least one database, for example, a relational database. A relational database is a database that maintains a set of separate, related files, but combines data elements from the files for queries and reports when required. In an aspect of the invention, the inference engine is in communication with a primary database 140 and at least one secondary database 150. The inference engine 120 is also in communication with a registry 160. In an aspect of the invention, the registry 160 is a semantic Universal Description Discovery and Integration (SUDDI) registry. Other types of registries could be used. The registry 160 is configured to contain as well as update information related to data stored in the primary database 140 and the at least one secondary database 150. The registry 160 may be further configured to update the information in substantially real time or near real time. In an aspect of the invention, the registry 160 is a stand-alone module; however, in other aspects, the registry 160 is logical structure in communication with the inference engine 120. In an aspect of the invention, the network 130 may be a wired or wireless wide or local area network as would be apparent to one of ordinary skill in the art, and the invention is not limited to any specific type.

The inference engine 120 is configured to access a set of rules with which it is enabled to operate. These rules may reside within the inference engine 120 itself or accessibly outside the inference engine 120 as would be apparent to one of ordinary skill in the art. The input 110 is received by the inference engine 120 and is parsed into in at least one subsequent-query. Each subsequent-query is analyzed against the set of rules, which dictate how the subsequent-queries are processed. By way of non-limiting example, the rules can be generally categorized into the following: user-centric, syntax-based, logic-based, and semantic-based. As would be apparent to one of ordinary skill in the art, other categories of rules, such as fuzzy logic-based rules, can also exist.

The user-centric rules might include security rules and/or regional rules. For example, different users may have different levels of security authorization. Furthermore, security may be based on an authorization level of different users' classifications, where one class of users may be authorized to perform a restricted level action while another class of users may be authorized to perform an unlimited level action. In response to a user-submitted query in such an instance, the system will refer to the user-centric security rules and would only return information appropriate to the users' authorization level. This may be implemented using, for example, a secure user identification, pin code, IP address identification, or any other user identification system or method as would be apparent to one of ordinary skill in the art. An example of a regional, user-centric rule may include rules that address a user's country code so that the system returns information relevant to and conforming with the local currency and/or time zone.

The syntax-based rules might include instructions, or algorithms, configured so that a required category of information is returned within the same category and/or rejects information outside of that category. For example, if a requested query category relates to currency, then the rules would only allow a currency answer. Such rules can be general, for example, where only numerical answers are returned (or preferred) for categories such as “currency.” Such rules can also be more specific, for example, where only answers that conform to a currency format are returned (or preferred) for categories such as “currency.”

The logic-based rules might include instructions, or algorithms, that analyses results based on a set of user-defined criteria. This user-defined criteria allows users to set likely expected range values so that returned results that are outside of this predefined range will be rejected and not returned to the user. It should be noted, however, that such “ranges” are not defined herein to exclude non-numerical results. Instead, a predefined range can include any parameters, for example, a range of colors, names, or any other criteria as would be apparent to one of ordinary skill in the art.

The semantic-based rules might include instructions, or algorithms, that takes each subsequent-query and performs a semantic analysis to create additional related terms for each subsequent-query. For example, if the subsequent-query was “license,” then the semantic logic would search for and find related terms with which to search the primary database 140 and the at least one secondary database 150. In this example, terms such as “contract” and “agreement” could be combined with the original subsequent-query “license” to be matched against the registry 160. Based upon the results of the matching, the inference engine 120 will query the appropriate database 140, 150. The database 140, 150 will return the results to the inference engine 120 and, ultimately, the user.

It should be understood that there may be other rules categories and other examples of rules within each category. (For example fuzzy logic-based rules, as would be apparent to one of ordinary skill in the art.) It should also be understood that the application of rules by the inference engine is not exclusive to the employment of other rules. By way of non-limiting example, once the semantic based-rules are consulted, the user-centric rules may determine if the results are being returned in the correct regional format, the syntax-based rules may determine if the results are of the same category as the original subsequent-query and additional semantic terms, and the logic-based rules may also determine if the results conform to an expect result range.

The database 140, 150 may include a primary database and a secondary database. However, it should be understood that system may include a plurality of primary databases. The system may also include a plurality of secondary databases. The collection of a plurality of databases may be, for example, what is known in the art as a Federation of databases. It should be understood, however, that the plurality of databases can by any form of data storage that is networked together, wired or wireless, through a WAN or LAN, or through the Internet. As would be apparent to one of ordinary skill in the art, a database can be, by way of non-limiting example, a magnetic storage device or an optical storage device, but may also: be any device capable of storing data accessible to network 130 or inference engine 120.

As would be apparent to one of ordinary skill in the art, the registry 160 could reside within any database 140, 150. Similarly, the registry 160 may also exist as and/or within a module or medium separate from database 140, 150.

By way of non-limiting example, and as would be apparent to one of ordinary skill in the art, a subsequent-query can be the result of a set of instructions, algorithm, and/or filtering rules 170. Such filtering rules can reside inside registry 160 or exist separate from registry 160 but is accessible via network 130. For example, the initial electronic query would have a certain scope. Said instructions, algorithms, and/or filtering rules 170 can be configured to create one or more subsequent-query with a scope more conditioned to providing an answer to the subsequent-query or the initial electronic query commensurate with the scope of the subsequent-query or the initial electronic query. In addition, it would be apparent to one of ordinary skill in the art that the subsequent-query could, in fact, be as broad or broader than the initial electronic query. Of course, the subsequent-query could also be narrower in scope that the initial electronic query.

In addition, another exemplary implementation may further parse a subsequent-query into a third, extended query whose scope may also be narrower, as broad, or broader than its parent queries. In other words, it would be apparent to one of ordinary skill in the art that extended queries (e.g. subsequent-queries, tertiary-queries, and so on . . . ) need not be narrower than the queries from which they evolve. By way of non-limiting example, parsing a query that includes a request for license information into a query for license, agreement, or contract information is at least as broad, if not broader, than the parent request, which was limited to “license information.” As a result, extended, child queries clearly do not require that they be narrower in scope than their parent queries. Such parsing of a query can be achieved through any of a number of known methods.

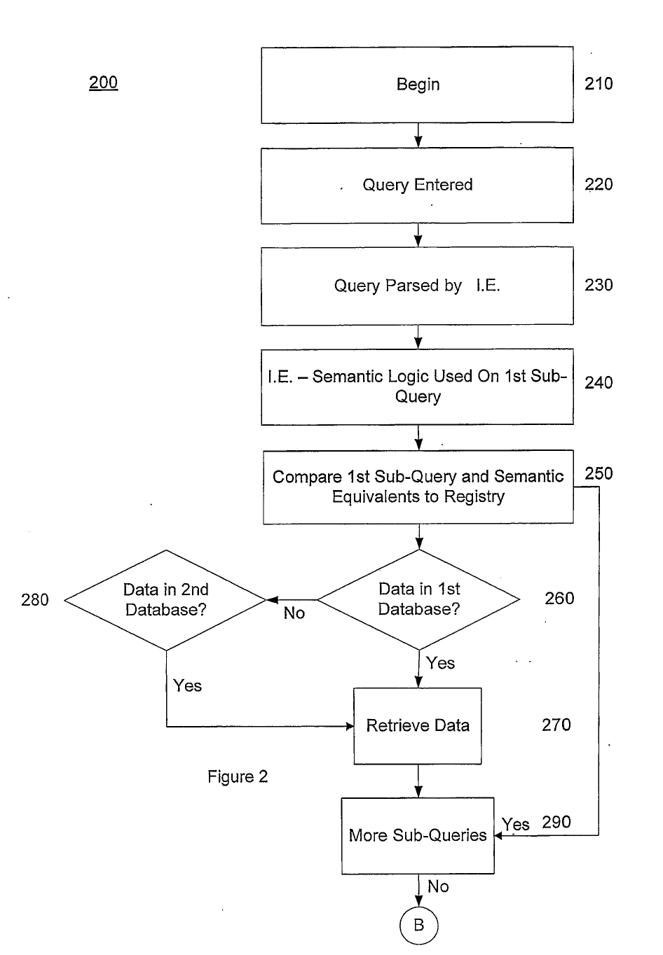

Referring now to FIG. 2, indicated generally by 200 is a flow chart illustrating a process in accordance with an aspect of the present invention fulfilling a user query using the system of FIG. 1. The process begins at 210 where a query is entered 220 into the inference engine 120. The query can include one or more subsequent-queries. To that end, the query is parsed and interpreted 230 into at least one subsequent-query. For the first subsequent-query, the inference engine 120 invokes the semantic logic and, within the set of rules, performs a semantic search 240 to identify related terms that are to be combined into the first subsequent-query. The first subsequent-query is compared 250 against the registry 160 to identify the location of the database which contains information related to the first subsequent-query. If the related information is found to be located in a primary data resource 260, the inference engine 120 performs a data request operation to retrieve the desired information 270. If the related information is found to be located in the at least one secondary database 280, the inference engine 120 performs a data request operation across network 130 to retrieve the desired information 270. The process is repeated on all subsequent subsequent-queries of the original query until all are searched 290.

The results from the first subsequent-query are transmitted to the inference engine 120, which invokes the user-centric, the syntax-based, and the logic-based rules to analyze the results. The user-centric rules 300 determines whether the results conform to, for example, the regional settings of the requesting user. If the results are within the specified limits 310, then the results are compared against the syntax-based rules. If they are not within limits 310, then the inference engine 120 passes the subsequent-query back to process 240. For example, if the first subsequent-query involved information related to the cost of a license agreement for a software package and the user's regional settings where set to U.S. (or detected to be U.S.), then the user-centric rules would determine if the results are in U.S. currency. If the results matched the regional settings, then the results would pass the user-centric rules; however, if the results were in Japanese Yen, then the user-centric rules would notify the inference engine 120. The inference engine could then convert the returned results into the format expected by the user or may invoke another process to perform the required conversion.

The syntax-based rules 320 determines whether the results conform to the category of information requested in the first subsequent-query. If the results are within the specified limits 330, then the results are compared against the syntax-based rules. If they are not within limits 330, then the inference engine 120 passes the subsequent-query back to process 240. Continuing with the example above where the query was for the cost of a license agreement, the expected category of information is currency. The syntax-based rules would determine whether the results are in a currency format and, if so, the results would pass the syntax-based rules. If the result are not in the proper category, the inference engine 120 will perform an operation to analyze the first subsequent-query using the semantic-based rules and begin the process again.

The logic-based rules 340 determines whether the results conform to the pre-defined user criteria. If the results are within the specified limits 350, then the results are compared against the logic-based rules. If they are not within limits 350, then the inference engine 120 passes the subsequent-query back to process 240. Still continuing with the example above, the expected result is a currency value and the likely amount that has been pre-defined for a single license is between US $50.00-$500.00. If the result is US $150.00, then this amount is determined by the logic-based rules to be acceptable. However, if the result is US $1.00, then this amount is outside of the pre-defined criteria and the inference engine 120 will perform an operation to analyze the first subsequent-query using the semantic-based rules and begin the process again.

In an aspect of the invention, inference engine 120 is configured to perform an analysis of the first subsequent-query and subsequent subsequent-queries contemporaneously. In other aspect of the invention, the inference engine 120 completes the first subsequent-query operation before initiating the subsequent subsequent-query operations. Once the first subsequent-query and subsequent subsequent-query operations are complete and the each result has passed the above rules, then the results are aggregated and transmitted to the user. However, it should be understood that it may be desirable to have the results returned to the user (or requesting computer) as they are received by the inference engine 120. This might, for example, allow for faster results as once the user is satisfied, the user can stop the entire process.

One or more embodiments or aspects of the present invention may be used with the system described in U.S. Provisional Application Ser. No. 60/871,479, the entirety of which is incorporated herein by reference. Thus, the invention may be used to query, access and retrieve data from a database containing profile of various service and process objects in a network with a service oriented architecture.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for processing an electronic query comprising:
providing the query to an inference engine;
using the inference engine for
(a) accessing at least one first data source for information responsive to the query and
(b) determining whether additional information is necessary to answer the query and, if so,
(i) accessing a registry containing descriptions of one or more additional data sources,
(ii) analyzing the descriptions of the one or more additional data resources to identify at least one additional data source relevant to the query; and
(iii) accessing the at least one additional data source for information responsive to the query;
aggregating all of the information responsive to the query; and
supplying an answer to the query.

2. The method of claim 1 wherein the descriptions are amenable to analysis by the inference engine.

3. The method of claim 1 wherein the inference engine is configured to automatically update the registry.

4. The method of claim 1 wherein the registry is configured to be manually updated by an authorized user.

5. The method of claim 1 further comprising filtering the query into one or more subsequent queries.

6. The method of claim 1 wherein the scope of the answer is commensurate with the scope of the query.

7. A method for processing an initial electronic query comprising:
defining a set of rules accessible to an inference engine and wherein the set of rules are configured for parsing the initial electronic query into one or more subsequent queries;
accessing a registry containing descriptions of one or more data resources;
analyzing the descriptions of the one or more data resources to locate information responsive to the subsequent-query;
applying the set of rules to the information;
aggregating all of the information responsive to the query; and
supplying an answer to the query that is compliant with the set of rules.

8. The method of claim 7 wherein the initial electronic query is supplied by a user.

9. The method of claim 8 wherein the user is a computer.

10. The method of claim 7 wherein the parsing includes filtering the initial electronic query into one or more subsequent queries.

11. The method of claim 7 wherein the scope of the answer is commensurate with the scope of the initial electronic query.

12. The method of claim 7 wherein the set of rules are configured to further parse at least one of the one or more subsequent queries into one or more extended queries.

13. The method of claim 12 wherein the one or more extended queries can be as broad or broader than the subsequent query or initial electronic query from which it is derived.

14. The method of claim 7 wherein the one or more subsequent queries can be as broad or broader than the initial electronic query from which it is derived.

15. The method of claim 7 wherein the descriptions are amenable to analysis by the inference engine.

16. The method of claim 7 wherein the inference engine is configured to automatically update the registry.

17. The method of claim 7 wherein the registry is configured to be manually updated by an authorized user.

18. The method of claim 7 wherein the inference engine further comprises hardware-encoded instructions.

19. The method of claim 7 wherein the inference engine further comprises software-encoded instructions.

20. The method of claim 7 wherein the descriptions include the type of information stored in the at least one additional data source.

21. The method of claim 7 wherein the descriptions include instructions for accessing or querying the at least one additional data source.

22. The method of claim 17 wherein the inference engine automatically updates the registry by scanning for changes to the at least one or more additional data sources.

23. The method of claim 22 wherein the inference engine scans for changes to the existence of, location of, and/or contents of the at least one or more additional data sources.

24. The method of claim 7 wherein the set of rules are further configured for determining what information is necessary to answer each subsequent query.

25. A system comprising:
a first data source;
a registry that further comprises a set of descriptions of at least one additional data source;
an inference engine configured to:
(a) receive a query,
(b) access the first data source in order to obtain information responsive to the query and, if necessary,
(c) consult the registry in order to locate and access an additional data source in order to obtain information responsive to the query; and
an aggregation module configured to collect the information and respond to the query.

26. The system of claim 25 wherein the descriptions are amenable to analysis by the inference engine.

27. The system of claim 25 wherein the inference engine is configured to automatically update the registry.

28. The system of claim 25 wherein the registry is configured to be manually updated by an authorized user.

29. The system of claim 25 wherein the inference engine further comprises hardware-encoded instructions.

30. The system of claim 25 wherein the inference engine further comprises software-encoded instructions.

31. The system of claim 25 wherein the descriptions include the type of information stored in the at least one additional data source.

32. The system of claim 25 wherein the descriptions include instructions for accessing or querying the at least one additional data source.

33. The system of claim 25 wherein the inference engine automatically updates the registry by scanning for changes to the at least one or more additional data sources.

34. The system of claim 33 wherein the inference engine scans for changes to the existence of, location of, and/or contents of the at least one or more additional data sources.

35. The system of claim 25 further configured to parse the query into one or more subsequent-queries.

36. The system of claim 35 wherein the information responsive to the query or one or more subsequent-queries is commensurate in scope with the query or one or more subsequent queries, respectively.
